(19) United States
(12) Patent Application Publication
(10) Pub. No.: US 2003/0160163 A1
(43) Pub. Date: Aug. 28, 2003

(54) Optical metrology target design for simultaneous measurement of multiple periodic structures

(76) Inventors: Alan Wong, San Jose, CA (US); Gary X. Cao, Santa Clara, CA (US); Rex Eiserer, Los Altos, CA (US)

Correspondence Address: FISH & RICHARDSON, PC, 4350 LA JOLLA VILLAGE DRIVE, SUITE 500, SAN DIEGO, CA, 92122, US

(21) Appl. No.: 10/083,877

(22) Filed: Feb. 25, 2002

(51) Int. Cl. H01J 3/14

(52) U.S. Cl. 250/237 R

(57) ABSTRACT

An optical metrology target is provided and has a first periodic structure and a second periodic structure. The first periodic structure has at least two features and a first pitch, and the second periodic structure has at least two features and a second pitch. The optical metrology target is illuminated with a light source, and an optical signal from the optical metrology target is received and analyzed.

### BACKGROUND

The following description relates to metrology, and more particularly to optical metrology.

In the production of semiconductor devices such as, for example, logic devices, including transistors, or memory arrays, including flash memory arrays, certain characteristics of the semiconductor devices often must be measured. For example, the length and width of features, such as the length of a transistor gate, called the “critical dimension” or “CD,” often must be measured. Similarly, the distance between features, such as the distance between features in a repeating structure, the printing bias between multiple groups of repeating structures, or the alignment error between layers of a multi-layer device (e.g., an overlay registration measurement) often must be measured. The repeating structures may be closely spaced, “nested” structures, or they may be “isolated” structures that are spaced further apart. For example, it may be desirable to quantify the bias between an isolated feature and a nested feature in the device manufacturing process.

Typically, features of a semiconductor device are measured using a scanning electron microscope (“SEM”). If the device has both nested features and isolated features, then two separate SEM measurements must be made, i.e., one measurement for the nested feature and one measurement for the isolated feature. The nested structure and the isolated structure often cannot be imaged simultaneously for measurement because, at high magnification, both structures may not be within the field of view due to the spatial separation between the two structures. Also, the isolated feature should not be too close to the nested structure because the charging effect from the electron beam during measurement of the nested structure could add uncertainty to the subsequent measurement of the isolated structure, or vice versa.

An SEM measurement may be considered a destructive measurement because of the charging effect, which alters a subsequent measurement of the same feature. It is common to fabricate a separate test pad on the device for measurement by SEM, rather than using the SEM to directly measure the features that are to be used in operation of the device. Using a separate test pad can take up valuable space on the semiconductor chip and does not provide direct measurement of the features of interest.

As the size of the semiconductor device features decrease, for example below 100 nanometers, the limits of conventional SEM measurement in critical dimension metrology are being reached.

Optical metrology or “scatterometry,” including optical critical dimension metrology or “spectroscopic CD,” is an emerging optical measurement technology based on light scattering from a repeating structure, such as, for example, a diffraction grating.

### DESCRIPTION OF DRAWINGS

FIGS. 1-3 are top views of optical metrology targets.

FIG. 4 is a top view of an optical metrology target using a flash memory array.

FIGS. 5 and 6 are top views of optical metrology targets.

FIGS. 7 and 8 are top views of optical metrology targets in different layers of a device.

FIG. 9 is a schematic flow diagram of a process for using an optical metrology target.

Like reference symbols in the various drawings indicate like elements.

### DETAILED DESCRIPTION

Optical metrology is often used as a means of measurement in device manufacturing, and optical metrology tools may be used for in-line or in-situ process control. Optical metrology is typically considered to be a non-destructive and non-invasive testing technique. A separate test pad may be made and used as an optical metrology target, an optical metrology target may be made so as to simulate features of a semiconductor device, or an optical metrology target may be the actual features of the semiconductor device. When the features of the device are used as the target, the measurements are performed on the structures of interest and savings in available space on the die are realized because no separate test pad needs to be fabricated.

An optical metrology target has multiple periodic structures for measurement. For example, the optical metrology target may have one or more nested structures and one or more isolated structures. As a further example, the optical metrology target may have two or more nested structures, or the target may have two or more isolated structures.

As an example, an optical metrology target may have a periodic structure that simulates the same lithographic printing condition for features in a dense area (i.e., a nested structure) by having the same periodicity or pitch (i.e., the same line-to-space ratio) of the nested structure. The target also may have a second periodic structure with a different periodicity or pitch. The pitch (i.e., line width plus space between lines) of the second periodic structure may be higher than that of the first periodic structure, and may be an isolated structure. As the distance between two features increases, the optical effect decreases. For example, a line-to-space ratio of 1:3 or beyond, such as a ratio of 1:5 or 1:10, may be considered equivalent to an isolated line. The second periodic structure may therefore simulate the printing condition for features in an open region, i.e. an isolated structure. Thus, by design, an optical metrology target may have lines of different widths or lines of different pitches. The difference in line width or pitch between the first periodic structure and the second periodic structure results in an optical effect that can lead to the desired measurements.

Also, an optical metrology target may have one or more periodic structures oriented with respect to one axis of the target and one or more periodic structures oriented with respect to another axis of the target. For instance, an optical metrology target may have two or more periodic structures oriented along an X axis of the target and two or more periodic structures oriented along a Y axis of the target, where the X axis and the Y axis are perpendicular.

The features of the periodic structures of the optical metrology target may have any shape, including rectilinear shapes such as rectangles and squares, and curvilinear shapes such as circles and ovals.

Additionally, a device with two or more layers may have an optical metrology target in one layer and an optical metrology target in a second layer. For example, a device having two or more layers may have an optical metrology target with two or more periodic structures in a first layer and a second optical metrology target having two or more periodic structures in a second layer, where the first layer is adjacent to the second layer.

A scatterometer is a tool typically used in optical critical dimension metrology. The scatterometer collects the optical signal that is scattered from one or more periodic structures on the optical metrology target when the target is illuminated by a light source. The response of the optical metrology target is analyzed, normally with the assistance of a software package that uses a rigorous model such as the rigorous coupled wave analysis (“RCWA”) model. This can efficiently simulate the diffraction behavior of periodic structures such as, for example, one dimensional gratings.

In an optical metrology target with more than one periodic structure, the optical signal can be analyzed as a combination of signals, typically with one signal per periodic structure. In other words, for the purpose of analysis, each periodic structure can normally be treated as an independent system. For example, in a target with two periodic structures, the resulting optical signal can be analyzed as a combination of two separate signals, one per periodic structure. Thus two separate models, such as RCWA models, can be used in simulating the combined response of the two periodic structures. This technique allows for simultaneous measurement of multiple periodic structures.

An optical metrology target may be designed to take advantage of higher order diffraction from the periodic structures. The higher order diffraction signals may or may not propagate depending on the wavelength of light used and the periodicity or pitch of the periodic structure. The combination of multiple gratings on the optical metrology target can be arranged so that higher order diffraction makes the individual periodicities or pitches distinguishable.

The light diffracted from a periodic structure is diffracted according to the equation:

Sin θₘ=Sin θᵢ+mλ/D

In this equation, θₘ is the mth order diffraction angle, θᵢ is the incident angle, m is the order, λ is the wavelength of the light, and D is the periodicity or pitch of the periodic structure. An order can be propagating only if |Sin θₘ|<1.

In certain cases, such as, for example, when there is a fractional periodicity ratio between periodic structures (i.e., the ratio of one periodicity to another periodicity is a fraction), the periodic structures can be arranged so that only one of the gratings produces a propagating order of diffraction other than the zeroth order diffraction signal.

For example, in a target with two periodic structures, the two periodic structures may be arranged so that only one of the structures produces a propagating order, such as the first order, other than the zeroth order diffraction signal. This propagating signal can be uniquely associated with one periodicity or pitch, and thus uniquely associated with one of the periodic structures. Thus, it is possible to distinguish between two periodic structures on the target in a simultaneous measurement.

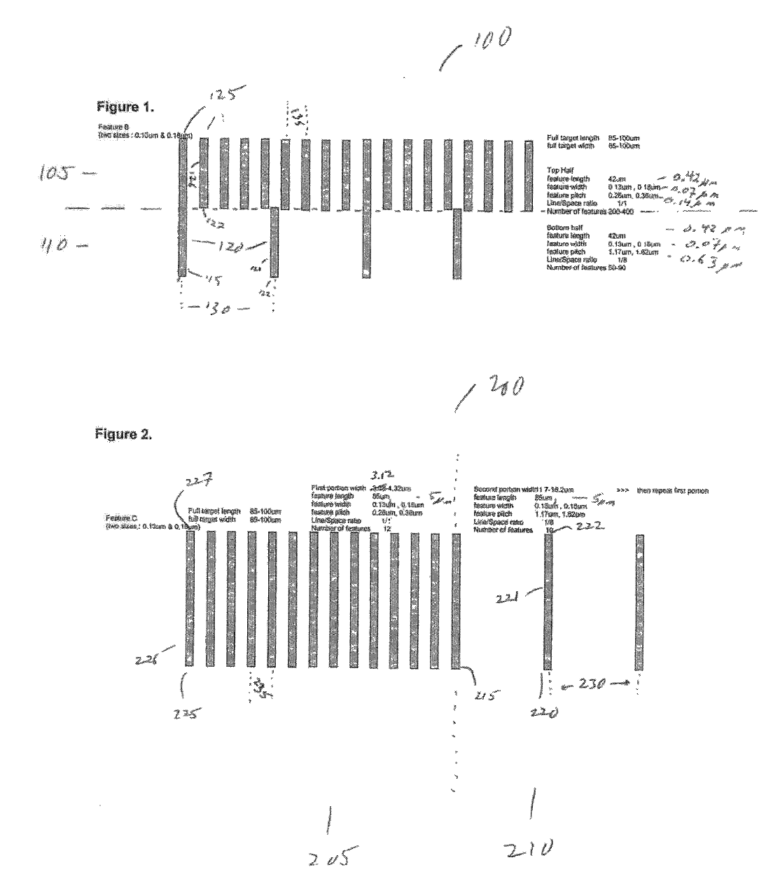

As shown in FIG. 1, an optical metrology target 100 has a first periodic structure 105 and a second periodic structure 110. The first periodic structure 105 has two or more features 125 with a periodicity or pitch 135. The features 125 have a length 126 and a width 127. The first periodic structure also may have features 115 that may be aligned with features of the second periodic structure 110, may be common or shared features of both the first periodic structure 105 and the second periodic structure 110, or may be connected to features of the second periodic structure 110.

The second periodic structure 110 has two or more features 120 with a periodicity or pitch 130. The features 120 have a length 121 and a width 122. The length 121 of feature 120 may be the same as or different from the length 126 of feature 125, and the width 122 of feature 120 may be the same as or different from the width 127 of feature 125. The pitch 130 of the second periodic structure 110 is different from the pitch 135 of the first periodic structure. The second periodic structure 110 also may have features 115 that are aligned with, in common or shared with, or connected to the first periodic structure 105.

The second periodic structure 110 is placed in a side-by-side configuration with the first periodic structure 105 so that an axis or center line of the first periodic structure 105 is parallel to an axis or center line of the second periodic structure 110. The second periodic structure 110 is adjacent to the first periodic structure 105, and optionally may be placed so as to overlap the first periodic structure 105.

Although FIG. 1 shows two periodic structures, more than two periodic structures may be oriented in the parallel side-by-side configuration shown in FIG. 1. For example, a third periodic structure having two or more features with a third periodicity or pitch may be employed. The third pitch may be different than the first pitch and the second pitch, and the features may have a length and a width that may be the same as or different from the length 121, 126 of features 120, 125 and the width 122, 127 of features 120, 125. The third periodic structure also may have features that are aligned with, in common or shared with, or connected to the first periodic structure 105, the second periodic structure 110, or both. Configurations with more than three periodic structures also may be employed.

The implementation of FIG. 1 has an example of two alternative feature widths 122, 127, corresponding to features 120, 125. The widths shown are 0.13 micrometers and 0.18 micrometers. In another implementation, feature width 122 and feature width 127 both have a value of 0.07 micrometers. However, any value of feature width 122, 127 may be used. For example, feature width 122, feature width 127, or both, may be less than 100 nanometers. Also, feature width 122 may be the same as or different from feature width 127.

The implementation FIG. 1 also shows an example of the length 126 of feature 125 and the length 121 of feature 120, both of which are 42 micrometers. In yet another implementation, feature length 121 and feature length 126 are both 0.42 micrometers. However, any value of length 121, 126 may be used. Also, the length 121 of feature 120 may be the same as or different from the length 126 of feature 125.

In the example of FIG. 1, the line-to-space ratio of the first periodic structure 105 is 1:1, which may be classified as a nested structure. However, other line-to-space ratios may be used in the first periodic structure 105. For example, a line-to-space ratio less than approximately 1:3 may be used for nested structures. However, the first periodic structure 105 may be an isolated structure, with the line-to-space ratio being approximately 1:3 or greater.

The pitch 135 of the first periodic structure 105 in FIG. 1 is 0.26 micrometers for the 0.13 micrometer feature width 127, or 0.36 micrometers for the 0.18 micrometer feature width 127. In yet another implementation, the pitch 135 of the first periodic structure 105 is 0.14 micrometers for the 0.07 micrometer feature width 127. However, other values for the pitch 135 of the first periodic structure 105 may be used, and will depend on, among other things, the feature width and the line-to-space ratio chosen. For example, the pitch 135 of the first periodic structure 105 may be less than 100 nanometers.

In the example of FIG. 1, the line-to-space ratio of the second periodic structure 110 is 1:8, which may be classified as an isolated structure. However, other line-to-space ratios may be used for the second periodic structure 110. For example, a line-to-space ratio equal to or greater than approximately 1:3 may be used for isolated structures. However, the second periodic structure 110 may be a nested structure, with the line-to-space ratio being less than approximately 1:3.

The pitch 130 of the second periodic structure 110 in FIG. 1 is 1.17 micrometers for the 0.13 micrometer feature width 122, or 1.62 micrometers for the 0.18 micrometer feature width 122. In yet another implementation, the pitch 130 of the second periodic structure 110 is 0.63 micrometers for the 0.07 micrometer feature width 122. However, other values for the pitch 130 of the second periodic structure 110 may be used, and will depend on, among other things, the feature width and the line-to-space ratio used. For example, the pitch 130 of the second periodic structure 110 may be less than 100 nanometers.

The first periodic structure 105 may have a total of N features, where N is typically an integer equal to or greater than 2. For example, the first periodic structure 105 shown in FIG. 1 may have between 200 to 400 features. However, any value of N may be used. The number of features used will affect the length of the first periodic structure.

The second periodic structure 110 may have a total of M features, where M is typically an integer equal to or greater than 2. For example, the second periodic structure 110 shown in FIG. 1 may have between 50 to 90 features. However, any value of M may be used. The number of features used will affect the length of the second periodic structure.

The overall length of the optical metrology target 100 shown in FIG. 1 is between 85-100 micrometers, and the overall width of the optical metrology target 100 is between 85-100 micrometers. However, any value for the overall length and width of the optical metrology target 100 may be used.

The optical metrology target 100 may be a separate test pad that may be built to mimic an electrical element such as, for example, a transistor gate or a flash memory array element. In other implementations, the optical metrology target may be the actual electrical elements, such as, for example, logic device elements including transistor gates or memory device elements including flash memory array elements. Any structure in the circuit, including both conductive structures and insulative structures, may be used as the optical metrology target. The optical metrology target 100 may be generated using the same set of design layout rules as are used in generating the electrical elements which the optical metrology target 100 is designed to mimic or which make up the target 100.

As shown in FIG. 2, an optical metrology target 200 has a first periodic structure 205 and a second periodic structure 210. The first periodic structure 205 has two or more features 225 with a periodicity or pitch 235. The features 225 have a length 226 and a width 227. The first periodic structure also may have features 215 that are common to features of the second periodic structure 210.

The second periodic structure 210 has two or more features 220 with a periodicity or pitch 230. The features 220 have a length 221 and a width 222. The length 221 of feature 220 may be the same as or different from the length 226 of feature 225, and the width 222 of feature 220 may be the same as or different from the width 227 of feature 225. The pitch 230 of the second periodic structure is different from the pitch 235 of the first periodic structure. The second periodic structure 210 also may have features 215 that are common to the first periodic structure 205.

The second periodic structure 210 is placed in a tandem configuration with the first periodic structure 205, so that an axis or center line of the first periodic structure 205 is aligned with or coaxial with an axis or center line of the second periodic structure 210. The second periodic structure 210 is adjacent to the first periodic structure 205, and optionally may be placed so as to overlap the first periodic structure 205.

The sequence of alternating tandem sections of first periodic structure 205 and second periodic structure 210 may continue for the entire width of the optical metrology target 200.

Although FIG. 2 shows two periodic structures, more than two periodic structures may be employed in the tandem configuration shown in FIG. 2. For example, a third periodic structure having two or more features with a third periodicity or pitch may be employed. The third pitch may be different from the first pitch and the second pitch. The features may have a length and a width that may be the same as or different from the length 221, 226 of features 220, 225 and the width 222, 227 of features 220, 225. The third periodic structure also may have features that are common to the first periodic structure 205, the second periodic structure 210, or both.

The implementation of FIG. 2 has an example of two alternative feature widths 222, 227, corresponding to features 220, 225. The widths shown are 0.13 micrometers and 0.18 micrometers. However, any value of feature width 222, 227 may be used. For example, feature width 222, feature width 227, or both, may be less than 100 nanometers. Also, feature widths 222 may be the same as or different from feature width 227.

The implementation of FIG. 2 also shows an example of the length 226 of feature 225 and the length 221 of feature 220, both of which are 85 micrometers. In another implementation, feature length 221 and feature length 226 are both 5 micrometers. However, any value of length 221, 226 may be used. Also, the length 221 of feature 220 may be the same as or different from the length 226 of feature 225.

In the example of FIG. 2, the line-to-space ratio of the first periodic structure 205 is 1:1, such that the first periodic structure may be classified as a nested structure. However, other line-to-space ratios may be used in the first periodic structure 205. For example, a line-to-space ratio less than approximately 1:3 could be used for nested structures. However, the first periodic structure 205 could be an isolated structure, with the line-to-space ratio being approximately 1:3 or greater.

The pitch 235 of the first periodic structure 205 in FIG. 2 is 0.26 micrometers for the 0.13 micrometer feature width 227, or 0.36 micrometers for the 0.18 micrometer feature width 227. However, other values for the pitch 235 of the first periodic structure 205 may be used, and will depend on, among other things, the feature width and the line-to-space ratio chosen. For example, the pitch 235 of the first periodic structure 205 may be less than 100 nanometers.

In the example of FIG. 2, the line-to-space ratio of the second periodic structure 210 is 1:8, such that the second periodic structure may be classified as an isolated structure. However, other line-to-space ratios may be used for the second periodic structure 210. For example, a line-to-space ratio equal to or greater than approximately 1:3 could be used for isolated structures. However, the second periodic structure 210 could be a nested structure, with the line-to-space ratio being less than approximately 1:3.

The pitch 230 of the second periodic structure 210 in FIG. 2 is 1.17 micrometers for the 0.13 micrometer feature width 222, or 1.62 micrometers for the 0.18 micrometer feature width 222. However, other values for the pitch 230 of the second periodic structure 210 may be used, and will depend on, among other things, the feature width and the line-to-space ratio used. For example, the pitch 230 of the second periodic structure 210 may be less than 100 nanometers.

The first periodic structure 205 may have a total of N features, where N is typically an integer equal to or greater than 2. For example, the first periodic structure 205 shown in FIG. 2 may have 12 features. The width of the first periodic structure, therefore, may be 3.12 micrometers for a 0.26 micrometer pitch or 4.32 micrometers for a 0.36 micrometer pitch. However, any value of N may be used, and the width of the first periodic structure will vary according to, among other things, the pitch and the value of N chosen.

The second periodic structure 210 may have a total of M features, where M is typically an integer equal to or greater than 2. For example, the second periodic structure 210 shown in FIG. 2 may have 10 features. The width of the second periodic structure, therefore, may be 11.7 micrometers for a 1.17 micrometer pitch or 16.2 micrometers for a 1.62 micrometer pitch. However, any value of M may be used, and the width of the second periodic structure will vary according to, among other things, the pitch and the value of M chosen.

The overall length of the optical metrology target 200 shown in FIG. 2 is between 85-100 micrometers, and the overall width of the optical metrology target 200 is between 85-100 micrometers. However, any value for the overall length and width of the optical metrology target 200 may be used.

The optical metrology target 200 may be a separate test pad that may be built to mimic an electrical element such as, for example, a transistor gate or a flash memory array element. In other implementations, the optical metrology target may be the actual electrical elements, such as, for example, logic device elements including transistor gates or memory device elements including flash memory array elements. The optical metrology target may be any structure in the circuit, including conductive structures and insulated structures. The optical metrology target 200 may be generated using the same set of design layout rules that are used to generate the electrical elements or any other structure in the circuit, including conductive structures and insulated structures, which the optical metrology target is designed to mimic or which make up the target 200.

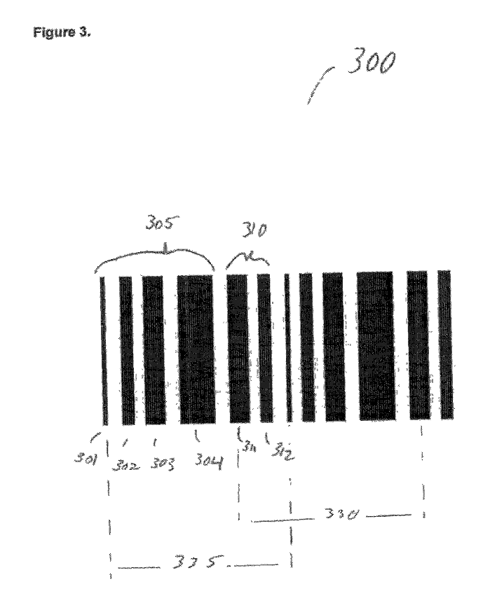

FIG. 3 shows another implementation of an optical metrology target 300 having multiple periodic structures. In particular, the optical metrology target 300 has a first periodic structure 305 and a second periodic structure 310. The first periodic structure has four features 301, 302, 303, 304, and a pitch 335. The widths of features 301-304 are not uniform. As shown in the example of FIG. 3, the width of feature 301 is less than the width of feature 302, the width of feature 302 is less that the width of feature 303, and the width of feature 303 is less than the width of feature 304.

The second periodic structure 310 has two feature 311, 312, and a pitch 330. The widths of features 311, 312 are not uniform. As shown in the example of FIG. 3, the width of feature 311 is greater than the width of feature 312. Also, as shown in the example of FIG. 3, the width of feature 311 is the same as the width of feature 303 and the width of feature 312 is the same as the width of feature 302.

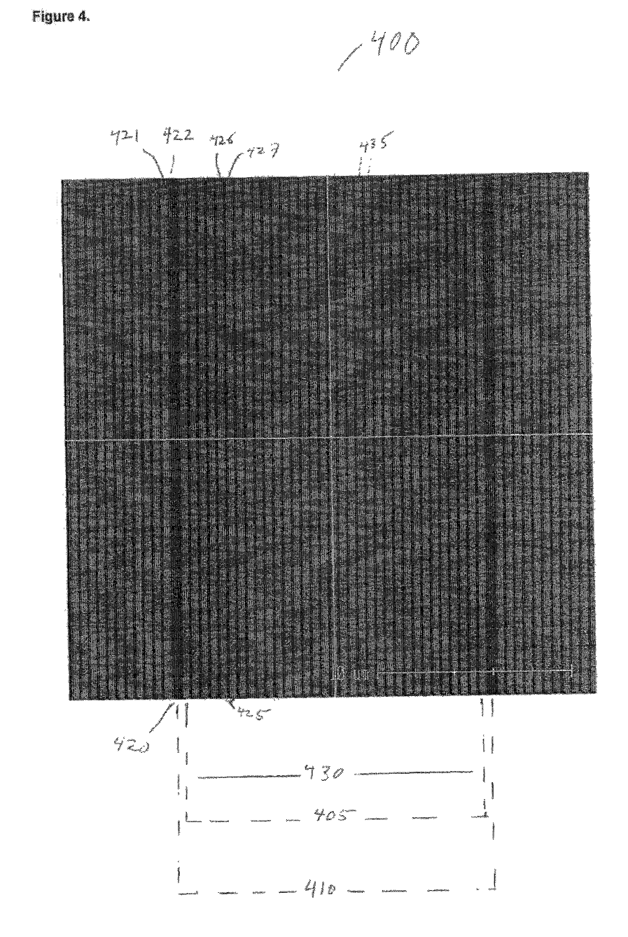

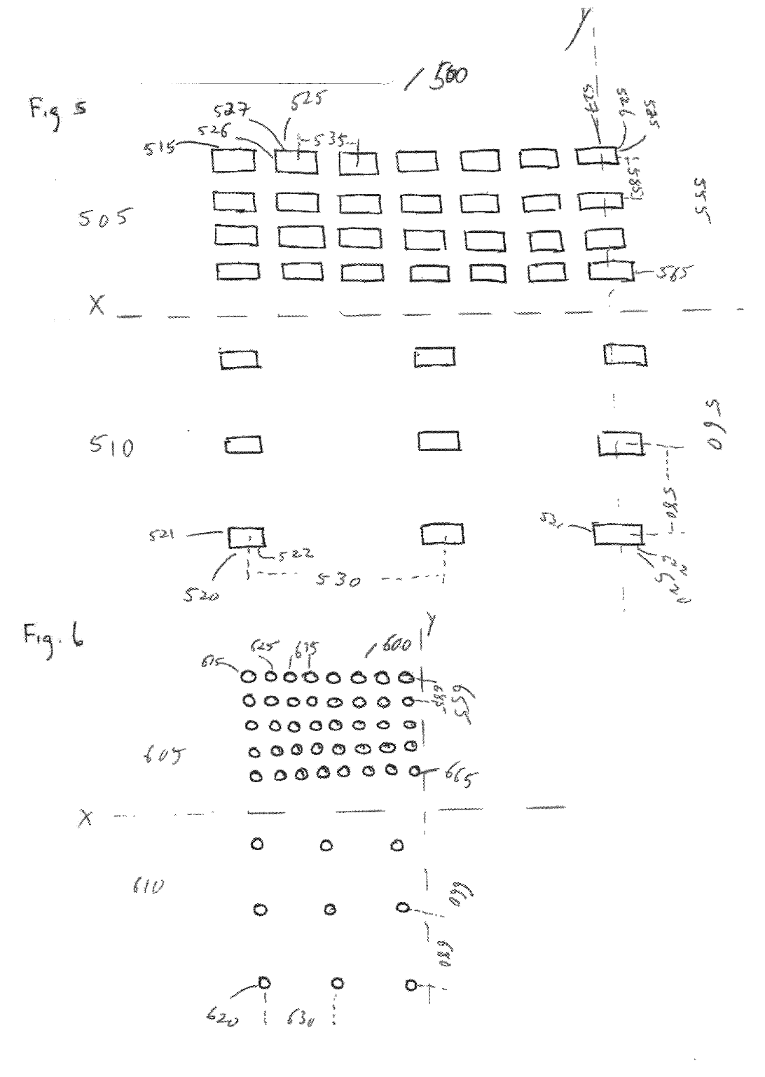

As shown in FIG. 4, an optical metrology target 400 may use electrical elements of an integrated circuit as the features of the periodic structures. In the example of FIG. 4, the periodic structures of a flash memory array form the first periodic structure 405 and the second periodic structure 410 of target 400. The first periodic structure 405 has two or more features 425 with a periodicity or pitch 435. The features 425 have a length 426 and a width 427. In the example of FIG. 4, the first periodic structure 405 is a nested structure.

The second periodic structure 410 has two or more features 420 with a periodicity or pitch 430. The features 420 have a length 421 and a width 422. As shown in FIG. 4, the width 427 of the features 425 of the first periodic structure 405 is different than the width 422 of the features 420 of the second periodic structure. In the example of FIG. 4, the second periodic structure 410 is an isolated structure.

The second periodic structure 410 is placed in a tandem configuration with the first periodic structure 405, so that an axis or center line of the first periodic structure 405 is aligned and coaxial with an axis or center line of the second periodic structure 410. The second periodic structure 410 is adjacent to the first periodic structure 405, and has been placed so as to overlap the first periodic structure 405.

The sequence of alternating sections of the first periodic structure 405 and the second periodic structure 410 in a tandem configuration may continue for the entire width of the optical metrology target 400.

As shown in FIG. 5, an optical metrology target 500 may have one or more periodic structures oriented with respect to the X axis of the target and one or more periodic structures 555, 560 oriented with respect to the Y axis of the target, where the X axis and the Y axis are perpendicular. In particular, FIG. 5 shows an optical metrology target 500 with two periodic structures 505, 510 oriented with respect to the X axis of the target and two periodic structures 555, 560 oriented with respect to the Y axis of the target.

The optical metrology target 500 has a first periodic structure 505 and a second periodic structure 510 that are oriented with respect to the X axis. The first periodic structure 505 has two or more features 525 with a periodicity or pitch 535. The features 525 have a length 526 and a width 527. The first periodic structure also may have features 515 that may be aligned with features of the second periodic structure 510, may be common or shared features of both the first periodic structure 505 and the second periodic structure 510, or may be connected to features of the second periodic structure 510. In the example of FIG. 5, the first periodic structure 505 is a nested structure.

The second periodic structure 510 has two or more features 520 with a periodicity or pitch 530. The features 520 have a length 521 and a width 522. The length 521 of feature 520 may be the same as or different from the length 526 of feature 525, and the width 522 of feature 520 may be the same as or different from the width 527 of feature 525. The pitch 530 of the second periodic structure 510 is different from the pitch 535 of the first periodic structure. The second periodic structure 510 also may have features 515 that are aligned with, in common or shared with, or connected to the first periodic structure 505. In the example of FIG. 5, the second periodic structure 510 is an isolated structure.

As shown in FIG. 5, the second periodic structure 510 is in a side-by-side configuration with the first periodic structure 505, so that the X axis is parallel to an axis or center line of both the first periodic structure 505 and the second periodic structure 510. Also, an axis or center line of the first periodic structure 505 is parallel to an axis or center line of the second periodic structure 510. The second periodic structure 510 is adjacent to the first periodic structure 505, and optionally may be placed so as to overlap the first periodic structure 505.

The optical metrology target 500 also has a third periodic structure 555 and a fourth periodic structure 560 that are oriented with respect to the Y axis. The third periodic structure 555 has two or more features 525 with a periodicity or pitch 585. The features 525 have a length 526 and a width 527. The third periodic structure also may have features 565 that may be aligned with features of the fourth periodic structure 560, may be common or shared features of both the third periodic structure 555 and the fourth periodic structure 560, or may be connected to features of the fourth periodic structure 560. In the example of FIG. 5, the third periodic structure 555 is a nested structure.

The fourth periodic structure 560 has two or more features 520 with a periodicity or pitch 580. The features 520 have a length 521 and a width 522. The length 521 of feature 520 may be the same as or different from the length 526 of feature 525, and the width 522 of feature 520 may be the same as or different from the width 527 of feature 525. The pitch 580 of the fourth periodic structure 560 is different from the pitch 585 of the third periodic structure. The pitch 580 of the fourth periodic structure 560 and the pitch 585 of the third periodic structure 555 may also be different from the pitch 535 of the first periodic structure 505 and the pitch 530 of the second periodic structure 510. The fourth periodic structure 560 also may have features 565 that are aligned with, in common or shared with, or connected to the third periodic structure 555. In the example of FIG. 5, the fourth periodic structure 560 is an isolated structure.

As shown in FIG. 5, the fourth periodic structure 560 is in a tandem configuration with the third periodic structure 555, so that the Y axis is parallel to an axis or center line of both the third periodic structure 555 and the fourth periodic structure 560. Also, an axis or center line of the third periodic structure 555 is aligned with or coaxial with an axis or center line of the fourth periodic structure 560. The fourth periodic structure 560 is adjacent to the third periodic structure 555, and optionally may be placed so as to overlap the third periodic structure 555.

Although FIG. 5 shows two periodic structures oriented along the X axis, more than two periodic structures may be oriented along the X axis. For example, a fifth periodic structure having two or more features with a fifth periodicity or pitch may be employed. The fifth pitch may be different than the first pitch and the second pitch, and the features may have a length and a width that may be the same as or different from the length 521, 526 of features 520, 525 and the width 522, 527 of features 520, 525. The fifth pitch may also be different than the third and fourth pitches. The fifth periodic structure also may have features that are aligned with, in common or shared with, or connected to the first periodic structure 505, the second periodic structure 510, or both. Configurations with more than three periodic structures also may be employed.

Although FIG. 5 shows two periodic structures oriented along the Y axis, more than two periodic structures may be oriented along the Y axis shown in FIG. 5. For example, a sixth periodic structure having two or more features with a sixth periodicity or pitch may be employed. The sixth pitch may be different than the third pitch and the fourth pitch, and the features may have a length and a width that may be the same as or different from the length 521, 526 of features 520, 525 and the width 522, 527 of features 520, 525. The sixth pitch may also be different than the first pitch, second pitch, and fifth pitch described above. The sixth periodic structure also may have features that are aligned with, in common or shared with, or connected to the third periodic structure 555, the fourth periodic structure 560, or both. Configurations with more than three periodic structures also may be employed.

The optical metrology target 500 may be a separate test pad that may be built to mimic an electrical element such as, for example, a transistor gate or a flash memory array element. In other implementations, the optical metrology target may be the actual electrical elements, such as, for example, logic device elements including transistor gates or memory device elements including flash memory array elements. Any structure in the circuit, including both conductive structures and insulative structures, may be used as the optical metrology target. The optical metrology target 500 may be generated using the same set of design layout rules as are used in generating the electrical elements which the optical metrology target 500 is designed to mimic or which make up the target 500.

The shape of the periodic structures 515, 520, 525, 565 of the optical metrology target 500 may be a rectilinear shape, such as, for example, a rectangle or a square. Other shapes, such as curvilinear shapes, may also be used.

The optical metrology target 600 shown in FIG. 6 has a configuration comparable to the optical metrology target 500 of FIG. 5. In particular, optical metrology target 600 has two periodic structures 605, 610 oriented with respect to the X axis of the target and two periodic structures 655, 660 oriented with respect to the Y axis of the target, where the X axis and the Y axis are perpendicular.

The optical metrology target 600 has a first periodic structure 605 and a second periodic structure 610 that are oriented with respect to the X axis. The first periodic structure 605 has two or more features 525 with a periodicity or pitch 635. In the example of FIG. 6, the first periodic structure 605 is a nested structure.

The second periodic structure 610 has two or more features 620 with a periodicity or pitch 630. The pitch 630 of the second periodic structure 610 is different from the pitch 635 of the first periodic structure 605. The pitch 630 of the second periodic structure 610 may also be different from the pitch 685 of the third periodic structure 655 and the pitch 680 of the fourth periodic structure 660, discussed below. In the example of FIG. 6, the second periodic structure 610 is an isolated structure.

As shown in FIG. 6, the second periodic structure 610 is in a side-by-side configuration with the first periodic structure 605, so that the X axis is parallel to an axis or center line of both the first periodic structure 605 and the second periodic structure 610. Also, an axis or center line of the first periodic structure 605 is parallel to an axis or center line of the second periodic structure 610. The second periodic structure 610 is adjacent to the first periodic structure 605, and optionally may be placed so as to overlap the first periodic structure 605.

The optical metrology target 600 also has a third periodic structure 655 and a fourth periodic structure 660 that are oriented with respect to the Y axis. The third periodic structure 655 has two or more features 625 with a periodicity or pitch 685. In the example of FIG. 6, the third periodic structure 655 is a nested structure.

The fourth periodic structure 660 has two or more features 620 with a periodicity or pitch 680. The pitch 680 of the fourth periodic structure 660 is different from the pitch 685 of the third periodic structure 655. The pitch 680 of the fourth periodic structure 660 may also be different from the pitch 635 of the first periodic structure 605 and the pitch 630 of the second periodic structure 610. In the example of FIG. 6, the fourth periodic structure 660 is an isolated structure.

As shown in FIG. 6, the fourth periodic structure 660 is in a tandem configuration with the third periodic structure 655, so that the Y axis is parallel to an axis or center line of both the third periodic structure 655 and the fourth periodic structure 660. Also, an axis or center line of the third periodic structure 655 is aligned with or coaxial with an axis or center line of the fourth periodic structure 660. The fourth periodic structure 660 is adjacent to the third periodic structure 655, and optionally may be placed so as to overlap the third periodic structure 655.

As shown in FIG. 6, the shape of the periodic structures 615, 620, 625, 665 of the optical metrology target 600 may be a curvilinear shape, such as, for example, a circle or an oval. Other shapes, such as rectilinear shapes, may be used.

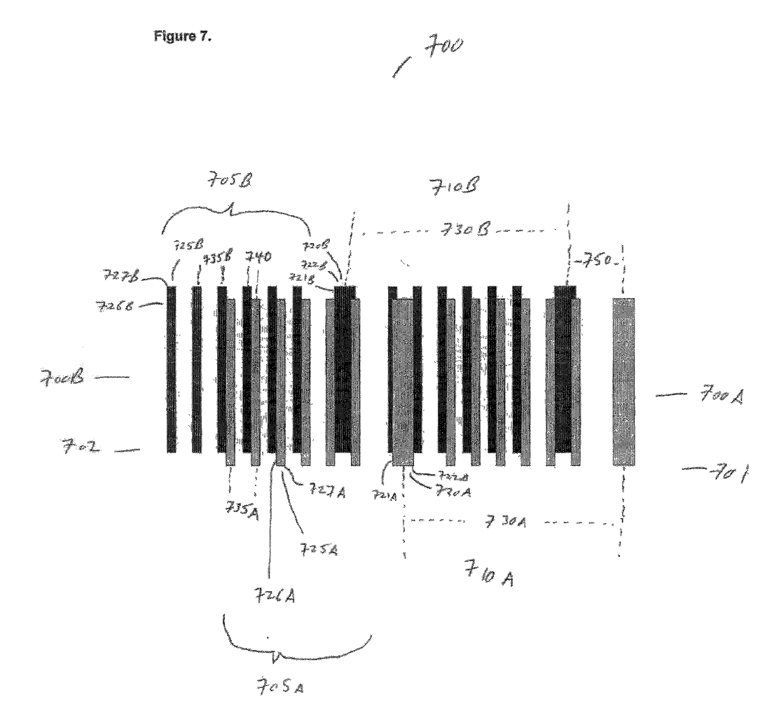

As shown in FIG. 7, a device 700 has at least two layers, 701 and 702, where layer 701 is located on top of layer 702. Layer 701 has an optical metrology target 700A, and layer 702 has a second optical metrology target 700B. Typically, it is desirable for the top layer 702 to align as closely as possible with the bottom layer 701, and it is desirable to obtain a measurement of the overlay registration between the layers.

In layer 701, optical metrology target 700A has a first periodic structure 705A and a second periodic structure 710A. The first periodic structure 705A has two or more features 725A with a periodicity or pitch 735A. The features 725A have a length 726A and a width 727A. The second periodic structure 710A has two or more features 720A with a periodicity or pitch 730A. The features 720A have a length 721A and a width 722A. The length 721A of feature 720A may be the same as or different from the length 726A of feature 725A. In the example of FIG. 7, the lengths 726A, 721A are the same. The width 722A of feature 720A may be the same as or different from the width 727A of feature 725A. In the example of FIG. 7, the widths 722A, 727A are different. The pitch 730A of the second periodic structure 710A is different from the pitch 735A of the first periodic structure 705A.

The second periodic structure 710A is placed in a tandem configuration with the first periodic structure 705A, so that an axis or center line of the first periodic structure 705A is aligned with or coaxial with an axis or center line of the second periodic structure 710A. The second periodic structure 710A is adjacent to the first periodic structure 705A, and optionally may be placed so as to overlap the first periodic structure 705A.

The sequence of alternating tandem sections of first periodic structure 705A and second periodic structure 710A may continue for the entire width of the optical metrology target 700A in the top layer 701.

In layer 702, second optical metrology target 700B has a third periodic structure 705B and a fourth periodic structure 710B. The third periodic structure 705B and fourth periodic structure 710B of the second optical metrology target 700B may have the same characteristics (e.g., length, width, pitch) as the first periodic structure 705A and the second periodic structure 710A, respectively, of optical metrology target 700A.

The third periodic structure 705B has two or more features 725B with a periodicity or pitch 735B. The features 725B have a length 726B and a width 727B.

The fourth periodic structure 710B has two or more features 720B with a periodicity or pitch 730B. The features 720B have a length 721B and a width 722B.

The length 721B of feature 720B may be the same as or different from the length 726B of feature 725B. In the example of FIG. 7, the lengths 726B, 721B are the same. Also, the lengths 726B, 721B are the same as lengths 726A, 721A.

The width 722B of feature 720B may be the same as or different from the width 727B of feature 725B. In the example of FIG. 7, the widths 722B, 727B are different. Also, the width 722B is the same as width 722A and width 727B is the same as width 727A in the example of FIG. 7.

The pitch 730B of the fourth periodic structure 710B is different from the pitch 735B of the third periodic structure 705B. However, in the example of FIG. 7, the pitch 730B is the same as the pitch 730A, and the pitch 735B is the same as the pitch 735A.

The fourth periodic structure 710B is placed in a tandem configuration with the third periodic structure 705B so that an axis or center line of the third periodic structure 705B is aligned with or coaxial with an axis or center line of the fourth periodic structure 710B. The fourth periodic structure 710B is adjacent to the third periodic structure 705B, and optionally may be placed so as to overlap the third periodic structure 705B.

The sequence of alternating tandem sections of third periodic structure 705B and fourth periodic structure 710B may continue for the entire width of the second optical metrology target 700B in the bottom layer 702.

The offset between layer 701 and layer 702 may be measured using optical metrology targets 700A and 700B. The offset distance 740 between the features 725A, 725B of first and third periodic structures 705A, 705B may be measured. The distance 750 between the features 720A, 720B of second and fourth periodic structures 710A, 710B may be measured. Offset distance 740 may contain a number of periods 735A, 735B in the error measurement. The exact number of periods present in the overlay registration measurement cannot be ascertained with a single periodic structure. Thus, more than one periodicity is needed in the optical metrology target to resolve this ambiguity. Distance 750 between features 720A, 720B gives an indication of the number of periods 735A, 735B present in offset measurement 740.

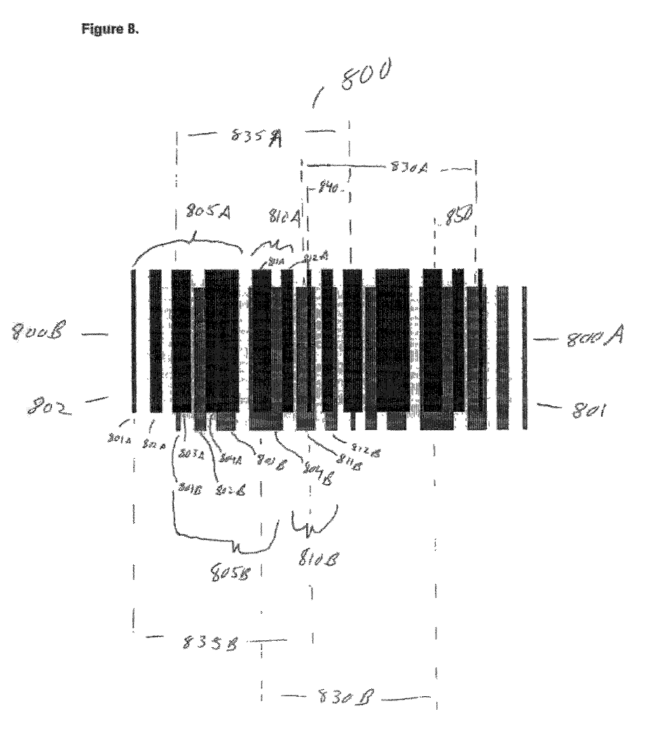

As shown in FIG. 8, a device 800 has at least two layers, 801 and 802, where layer 801 is located on top of layer 802. Layer 801 has an optical metrology target 800A, and layer 802 has a second optical metrology target 800B. Optical metrology targets 800A, 800B have the structure of the optical metrology target 300 described above with respect to FIG. 3.

In particular, the optical metrology targets 800A, 800B have first and third periodic structures 805A, 805B comparable to the first periodic structure 305, and second and fourth periodic structures 810A, 810B comparable to the second periodic structure 310, as described above with respect to FIG. 3.

The first and third periodic structures 805A, 805B each have four features, 801A, 802A, 803A, 804A and 801B, 802B, 803B, 804B, comparable to features 301, 302, 303, and 304, with the first periodic structure having features 801A, 802A, 803A and 804A, and the third periodic structure having features 801B, 802B, 803B and 804B. The structures also have pitches 835A, 835B comparable to pitch 335. The widths of features 801A-804A and 801B-804B are not uniform, and are comparable to the widths of features 301-304, as described above with respect to FIG. 3.

The second and fourth periodic structures 810A, 810B each have two features, 811A, 812A and 811B 812B, comparable to features 311, 312, with the second periodic structure having features 811A and 812A, and the fourth periodic structure having features 811B and 812B. The structures also have pitches 830A, 830B comparable to pitch 330. The widths of features 811A, 812A and 811B, 812B are not uniform, and are comparable to the widths of features 311, 312, as described above with respect to FIG. 3.

The offset between layer 801 and layer 802 may be measured using optical metrology targets 800A and 800B. The offset distance 840 between the features 825A, 825B of first and third periodic structures 805A, 805B may be measured. The distance 850 between the features 820A, 820B of second and fourth periodic structures 810A, 810B may be measured. Offset distance 840 may contain a number of periods 835A, 835B in the error measurement. The exact number of periods in present in the overlay registration measurement cannot be ascertained with a single periodic structure. Thus, more than one periodicity is needed in the optical metrology target to resolve this ambiguity. Distance 850 between features 820A, 820B gives an indication of the number of periods 835A, 835B present in offset measurement 840.

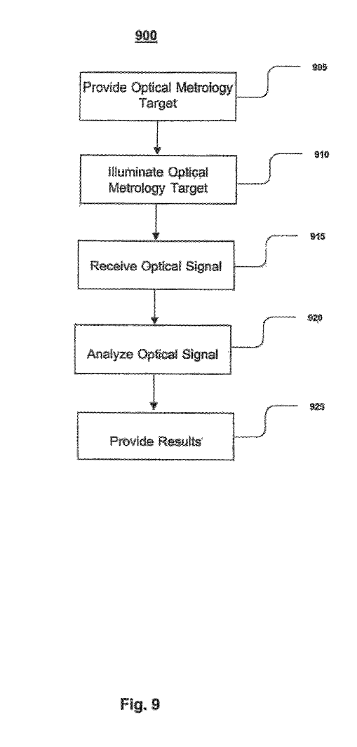

FIG. 9 illustrates a process 900 for obtaining measurements using an optical metrology target. Initially, an optical metrology target is provided (905). The target may have attributes similar to the optical metrology target 100, 200, 300, 400, 500, 600, 700A, 700B, 800A, or 800B described above with respect to FIGS. 1-8, respectively. The optical metrology target is illuminated with a light source (910). The light source may have a frequency, for example, in the visible or ultraviolet spectrum. The light source may be a coherent source, such as, for example, a laser, or the light source may be a non-coherent source, such as, for example, a halogen bulb or a xenon bulb. The light from the light source impinges on the optical metrology target at an incident angle, and is scattered at a diffraction angle.

The diffracted light is used as an optical signal that is received (915). Multiple channels may be used for detection of the optical signal. For example, more than one signal detector may be positioned at one or more angles and/or one or more locations to receive the optical signal.

The optical signal is analyzed (920). The analysis may be assisted in part by a software program using a rigorous model such as the RCWA model. The optical signal may be analyzed as a separate set of independent optical signals for each of the periodic structures on the optical metrology target.

The analysis will provide a result (925), which may include a result for the pitch of each periodic structure on the optical metrology target, the bias between periodic structures, the overlay registration between different layers in a multi-layer device, and also may provide information about the width of the features making up the periodic structure. In this process 900, the measurements of all of the periodic structures on the optical metrology target are obtained simultaneously.

A number of implementations have been described. Nevertheless, it will be understood that various modifications may be made. For example, the optical metrology target may have more than two periodic structures, and may have multiple periodic structures in more than one dimension. For example, multiple periodic structures may be aligned with respect to one or more axes of the optical metrology target. The shape of the features in the periodic structures may vary and may be, for example, a square, a rectangular, an oval, or round. Other shapes for the features of the periodic structure, including other rectilinear figures and other curvilinear figures, are possible. In addition, the pitch, width, and length of each of the periodic structures may be varied. The physical arrangement of the periodic structures may be non-adjacent, adjacent, side-by-side, in tandem, overlapping, non-overlapping, or any combination of these, and may be aligned in one or more dimensions. The optical metrology target may also have multiple periodic structures in more than one layer of a device. Accordingly, other implementations are within the scope of the following claims.

What is claimed is:

1. A method of measuring comprising:
providing an optical metrology target, the optical metrology target comprising:
a first periodic structure comprising at least two features, the first periodic structure having a first pitch; and
a second periodic structure comprising at least two features, the second periodic structure having a second pitch that differs from the first pitch;
illuminating the optical metrology target with a light source;
receiving an optical signal from the optical metrology target; and
analyzing the optical signal.

2. The method of claim 1 in which analyzing the optical signal comprises determining the first pitch.

3. The method of claim 2 in which analyzing the optical signal further comprises determining the second pitch.

4. The method of claim 3 in which analyzing the optical signal comprises determining the first pitch and the second pitch simultaneously.

5. The method of claim 1 in which the measurement is non-destructive.

6. The method of claim 1 in which the light source comprises a coherent light source.

7. The method of claim 1 in which the light source comprises a non-coherent light source.

8. The method of claim 1 in which the light source comprises a light source in the visible spectrum.

9. The method of claim 1 in which the light source comprises a light source in the ultraviolet spectrum.

10. The method of claim 1 in which analyzing the optical signal comprises using a computer program.

11. The method of claim 1, in which the optical metrology target comprises a standalone test pad.

12. The method of claim 1, in which the optical metrology target mimics an electrical element.

13. The method of claim 12, in which the optical metrology target mimics a circuit structure.

14. The method of claim 13, in which the optical metrology target mimics a conductive structure.

15. The method of claim 13, in which the optical metrology target mimics an insulated structure.

16. The method of claim 15, in which the optical metrology target mimics a flash memory array.

17. The method of claim 1, in which the optical metrology target comprises two or more electrical elements.

18. The method of claim 1, in which the optical metrology target comprises a circuit structure.

19. The method of claim 18, in which the optical metrology target comprises a conductive structure.

20. The method of claim 17, in which the electrical element comprises a memory device element.

21. The method of claim 17, in which the electrical element comprises a logic device element.

22. The method of claim 1 in which each first feature comprises a width less than 100 nanometers.

23. The method of claim 1 in which the first pitch is less than 100 nanometers.

24. The method of claim 1 in which the first periodic structure is located adjacent to the second periodic structure.

25. The method of claim 1 in which the first periodic structure is located so as to overlap the second periodic structure.

26. The method of claim 1 in which an axis of the first periodic structure is parallel to an axis of the second periodic structure.

27. The method of claim 1 in which an axis of the first periodic structure is aligned with an axis of the second periodic structure.

28. The method of claim 1 in which at least one feature of the first periodic structure is a feature of the second periodic structure.

29. The method of claim 1 in which at least one feature of the first periodic structure is aligned with a feature of the second periodic structure.

30. The method of claim 1 in which at least one feature of the first periodic structure is connected to a feature of the second periodic structure.

31. The method of claim 1 in which the features of the first periodic structure comprise nested features.

32. The method of claim 31 in which a line-to-space ratio of the features of the first periodic structure comprises a value less than 1:3.

33. The method of claim 1 in which the features of the second periodic comprise isolated features.

34. The method of claim 33 in which a line--to-space ratio of the features of the second periodic structure comprises a value greater than or equal to 1:3.

35. The method of claim 1 in which the optical metrology target further comprises:
a third periodic structure comprising at least two features, the third periodic structure having a third pitch; and
a fourth periodic structure comprising at least two features, the fourth periodic structure having a fourth pitch that differs from the third pitch.

36. The method of claim 35 in which:
the first periodic structure and the second periodic structure are aligned with respect to a first axis of the optical metrology target; and
the third periodic structure and the fourth periodic structure are aligned with respect to a second axis of the optical metrology target.

37. The method of claim 36 in which analyzing the optical signal comprises determining the third pitch.

38. The method of claim 31 in which analyzing the optical signal comprises determining the fourth pitch.

39. The method of claim 1 in which a shape of at least two features of the first periodic structure comprises a rectilinear shape.

40. The method of claim 1 in which a shape of at least two features of the first periodic structure comprises a curvilinear shape.

41. The method of claim 1 in which the optical metrology target is provided in a first layer of a device.

42. The method of claim 41 further comprising:
providing a second optical metrology target in a second layer of the device, the second optical metrology target comprising:
a third periodic structure comprising at least two features, the third periodic structure having a third pitch; and
a fourth periodic structure comprising at least two features, the fourth periodic structure having a fourth pitch that differs from the third pitch.

43. The method of claim 42 in which analyzing the optical signal comprises determining the offset between the optical metrology target in the first layer of the device and the second optical metrology target in the second layer of the device.

44. The method of claim 43 in which:
the third pitch of the second optical metrology target in the second layer of the device is equal to the first pitch of the optical metrology target in the first layer of the device; and
the fourth pitch of the second optical metrology target in the second layer of the device is equal to the second pitch of the optical metrology target in the first layer of the device.

45. An optical metrology target comprising:
a first periodic structure comprising at least two features, the first periodic structure having a first pitch; and
a second periodic structure comprising at least two features, the second periodic structure having a second pitch that differs from the first pitch.

46. The optical metrology target of claim 45 in which:
each first feature further comprises a length and a width; and
each second feature further comprises a length and a width.

47. The optical metrology target of claim 46 in which the length of each first feature is equal to the length of each second feature.

48. The optical metrology target of claim 47 in which the width of each first feature is equal to the width of each second feature.

49. The optical metrology target of claim 46 in which the width of each first feature is less than 100 nanometers.

50. The optical metrology target of claim 45 in which the first pitch is less than 100 nanometers.

51. The optical metrology target of claim 45 in which the first periodic structure is located adjacent to the second periodic structure.

52. The optical metrology target of claim 45 in which the first periodic structure is located so as to overlap the second periodic structure.

53. The optical metrology target of claim 45 in which an axis of the first periodic structure is parallel to an axis of the second periodic structure.

54. The optical metrology target of claim 45 in which an axis of the first periodic structure is aligned with an axis of the second periodic structure.

55. The optical metrology target of claim 45 in which at least one feature of the first periodic structure is a feature of the second periodic structure.

56. The optical metrology target of claim 45 in which at least one feature of the first periodic structure is aligned with a feature of the second periodic structure.

57. The optical metrology target of claim 45 in which at least one feature of the first periodic structure is connected to a feature of the second periodic structure.

58. The optical metrology target of claim 45 in which the features of the first periodic structure comprise nested features.

59. The optical metrology target of claim 58 in which a line-to-space ratio of the features of the first periodic structure comprises a value less than 1:3.

60. The optical metrology target of claim 45 in which the features of the second periodic comprise isolated features.

61. The optical metrology target of claim 60 in which a line-to-space ratio of the features of the second periodic structure comprises a value greater than or equal to 1:3.

62. An integrated circuit comprising:
at least one electrical element; and
an optical metrology target, the optical metrology target comprising:
a first periodic structure comprising at least two features, the first periodic structure having a first pitch; and
a second periodic structure comprising at least two features, the second periodic structure having a second pitch that differs from the first pitch.

63. The integrated circuit of claim 62, in which the optical metrology target comprises a standalone test pad.

64. The integrated circuit of claim 62, in which the optical metrology target mimics the electrical element.

65. The integrated circuit of claim 64, in which the optical metrology target mimics a flash memory array.

66. The integrated circuit of claim 64, in which the optical metrology target comprises a circuit structure.

67. The integrated circuit of claim62, in which the optical metrology target comprises two or more electrical elements.

68. The integrated circuit of claim 62 in which the first periodic structure is located adjacent to the second periodic structure.

69. The integrated circuit of claim 62 in which the first periodic structure is located so as to overlap the second periodic structure.

70. The integrated circuit of claim 62 in which at least one feature of the first periodic structure is a feature of the second periodic structure.

71. The integrated circuit of claim 62 in which at least one feature of the first periodic structure is aligned with a feature of the second periodic structure.

72. The integrated circuit of claim 62 in which at least one feature of the first periodic structure is connected to a feature of the second periodic structure.

73. The integrated circuit of claim 62 in which the optical metrology target further comprises:
a third periodic structure comprising at least two features, the third periodic structure having a third pitch; and
a fourth periodic structure comprising at least two features, the fourth periodic structure having a fourth pitch that differs from the third pitch.

74. The integrated circuit of claim 73 in which:
the first periodic structure and the second periodic structure are aligned with respect to a first axis of the optical metrology target; and
the third periodic structure and the fourth periodic structure are aligned with respect to a second axis of the optical metrology target.

75. The integrated circuit of claim 74 in which the first axis of the optical metrology target is perpendicular to the second axis of the optical metrology target.

76. The integrated circuit of claim 74 in which analyzing the optical signal comprises determining the third pitch.

77. The integrated circuit of claim 74 in which analyzing the optical signal comprises determining the fourth pitch.

78. The integrated circuit of claim 62 in which a shape of at least two features of the first periodic structure comprises a rectilinear shape.

79. The integrated circuit of claim 62 in which a shape of at least two features of the first periodic structure comprises a curvilinear shape.

80. The integrated circuit of claim 62 in which the optical metrology target is provided in a first layer of a device.

81. The integrated circuit of claim 80 further comprising:
providing a second optical metrology target in a second layer of the device, the second optical metrology target comprising:
a third periodic structure comprising at least two features, the third periodic structure having a third pitch; and
a fourth periodic structure comprising at least two features, the fourth periodic structure having a fourth pitch that differs from the third pitch.

82. The integrated circuit of claim 81 in which analyzing the optical signal comprises determining the offset between the optical metrology target in the first layer of the device and the second optical metrology target in the second layer of the device.

83. The integrated circuit of claim 82 in which:
the third pitch of the second optical metrology target in the second layer of the device is equal to the first pitch of the optical metrology target in the first layer of the device; and
the fourth pitch of the second optical metrology target in the second layer of the device is equal to the second pitch of the optical metrology target in the first layer of the device.

84. An integrated circuit comprising:
at least one electrical element; and
an optical metrology target, the optical metrology target comprising:
a first means for measuring a first periodic structure; and
a second means for measuring a second periodic structure.

85. The integrated circuit of claim 84, in which the optical metrology target comprises a standalone test pad.

86. The integrated circuit of claim 84, in which the optical metrology target mimics the electrical element.

87. The integrated circuit of claim 84, in which the optical metrology target mimics a circuit structure.

88. The integrated circuit of claim 86, in which the optical metrology target mimics a memory device element.

89. The integrated circuit of claim 84, in which the optical metrology target comprises two or more electrical elements.

90. The integrated circuit of claim 84 in which:
the first means for measuring a first periodic structure comprises a means for measuring a first pitch of the first periodic structure; and
the second means for measuring a second periodic structure comprises a means for measuring a second pitch of the second periodic structure;
in which the second pitch differs from the first pitch.
